(19) United States
(12) Patent Application Publication
(10) Pub. No.: US 2016/0282527 A1
(43) Pub. Date: Sep. 29, 2016

(54) GLASS PLATE, AND METHOD OF PROCESSING GLASS PLATE

(71) Applicant: Asahi Glass Company, Limited, Chiyoda-ku (JP)

(72) Inventors: Isao SAITO, Chiyoda-ku (JP); Takahiro NAGATA, Chiyoda-ku (JP); Takuma FUJIWARA, Chiyoda-ku (JP)

(73) Assignee: Asahi Glass Company, Limited, Tokyo (JP)

(21) Appl. No.: 15/176,341

(22) Filed: Jun. 8, 2016

Related U.S. Application Data
(63) Continuation of application No. PCT/JP2014/083369, filed on Dec. 17, 2014.

(30) Foreign Application Priority Data
Dec. 27, 2013 (JP) 2013-273330

(51) Int. Cl. G02B 5/18; B23K 26/38; B23K 26/402; C03B 33/09

(52) U.S. Cl. CPC G02B 5/1852; C03B 33/091; B23K 26/38; B23K 26/402; B23K 2203/54

(57) ABSTRACT

A glass plate has, at least at a part of an outer edge, an adjacent surface that intersects a principal plane at an obtuse angle, wherein the adjacent surface is a cutting plane formed by an extension of a crack, and the adjacent surface forms a diffraction grating including at least one of a Wallner line and an Arrest line.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2014/083369 filed on Dec. 17, 2014 and designating the U.S., which claims priority of Japanese Patent Application No. 2013-273330 filed on Dec. 27, 2013. The entire contents of the foregoing applications are incorporated herein by reference.

### BACKGROUND OF THE INVENTION

1. Field of the Invention

The present invention relates to a glass plate, and a method of processing a glass plate.

2. Description of the Related Art

After being cut out to be a desired size, a glass plate may be chamfered. The chamfered glass plate has, on an outer edge, an adjacent surface that intersects a principal plane at an obtuse angle (cf. Patent Document 1 (Japanese Unexamined Patent Publication No. 2008-93744), for example).

Since a glass plate is transparent, it is difficult to visually recognize an outer edge of the glass plate. There is a problem that, if it is difficult to visually recognize the outer edge of the glass plate, upon a worker, who carries the glass, for example, attempting to hold the outer edge of the glass plate, it is difficult to recognize a position to be held, so that it is difficult to handle the glass plate.

There is a need for a glass plate that is superior in visibility of an outer edge.

### SUMMARY OF THE INVENTION

According to an aspect of the present invention, there is provided a glass plate including, at least at a part of an outer edge, an adjacent surface that intersects a principal plane at an obtuse angle, wherein the adjacent surface is a cutting plane formed by an extension of a crack, and the adjacent surface forms a diffraction grating including at least one of a Wallner line and an Arrest line.

According to another aspect of the present invention, there is provided a method of processing a glass plate including a step of forming, in the glass plate, an adjacent surface that intersects a principal plane of the glass plate at an obtuse angle by locally heating the glass plate by irradiation of a laser beam, and by displacing a position where the laser beam is irradiated, wherein the adjacent surface is a cutting plane formed by an extension of a crack, and the adjacent surface forms a diffraction grating including at least one of a Wallner line and an Arrest line.

According to another aspect of the present invention, there is provided a method of processing a glass plate including a step of simultaneously forming, in the glass plate, a first adjacent surface that intersects a first principal plane of the glass plate at an obtuse angle and a second adjacent surface that intersects a second principal plane of the glass plate at an obtuse angle by locally heating the glass plate by irradiation of a laser beam, and by displacing a position where the laser beam is irradiated, wherein each of the first adjacent surface and the second adjacent surface is a cutting plane formed by an extension of a crack, and each of the first adjacent surface and the second adjacent surface forms a diffraction grating including at least one of a Wallner line and an Arrest line.

According to an aspect of the present invention, there can be provided a glass plate that is superior in visibility of an outer edge.

Other objects, features and advantages of the present invention will become more apparent from the following detailed description when read in conjunction with the accompanying drawings.

### BRIEF DESCRIPTION OF THE DRAWINGS

FIG. 1 is a cross-sectional view of a glass plate according to an embodiment of the present invention;

FIG. 2 is a plan view of the glass plate of FIG. 1;

FIG. 3 is a side view illustrating a laser processing method of the glass plate according to Example 1;

FIG. 4 is a plan view illustrating a direction of scanning of a laser beam with respect to the glass plate of FIG. 3;

FIG. 5 is a side view illustrating a state of the glass plate after the laser processing of FIG. 3 to FIG. 4;

FIG. 6 is a side view illustrating a state of the glass plate of FIG. 5 after stress is applied;

FIG. 7 is a micrograph of a first adjacent surface of the glass plate illustrated in FIG. 6;

FIG. 8 is a micrograph of a second adjacent surface of the glass plate illustrated in FIG. 6;

FIG. 9 is a plan view illustrating a direction of scanning a laser beam with respect to the glass plate in Example 2;

FIG. 10 is a side view illustrating a state of the glass plate after the laser processing of FIG. 9;

FIG. 11 is a side view illustrating a state of the glass plate of FIG. 10 after stress is applied; and

FIG. 12 is a micrograph of a first adjacent surface of the glass plate illustrated in FIG. 11.

### DESCRIPTION OF THE PREFERRED EMBODIMENTS

An embodiment for implementing the present invention is described below by referring to the drawings. In each drawing, identical or corresponding symbols are assigned to identical or corresponding configurations, and thereby the descriptions are omitted. In the following description, “-” representing a numerical range implies a range including numerical values before and after the numerical range.

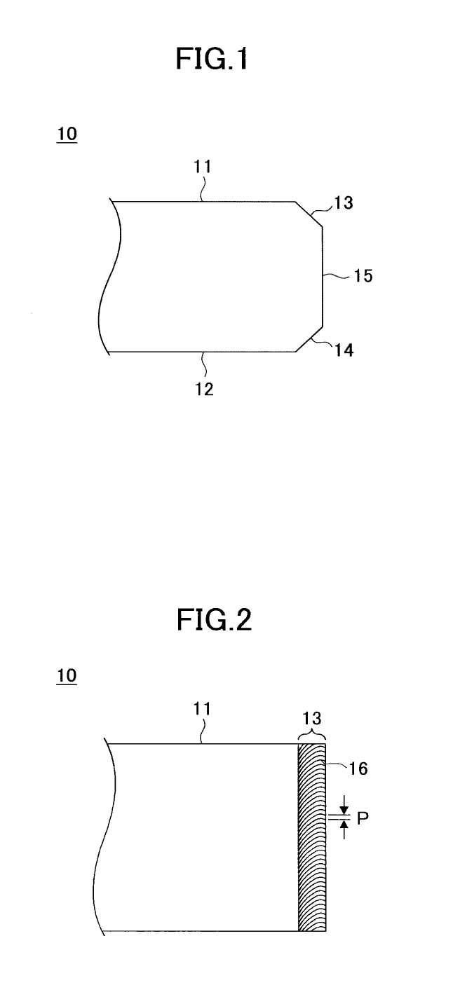

FIG. 1 is a cross section of a glass plate according to the embodiment of the present invention. FIG. 2 is a plan view of the glass plate.

The glass plate 10 is used, for example, as a window glass for a vehicle, a window glass for a building, a substrate for a display, or a cover glass for a display. The glass plate 10 may be formed of, for example, a soda-lime glass, an alkali-free glass, or a chemically strengthened glass. After applying a chemically strengthening process, the chemically strengthened glass is used as a cover glass, for example.

In FIG. 1, the glass plate 10 is a flat plate; however, the glass plate 10 may be a curved plate. The shape of the glass plate 10 is not particularly limited; however, the shape of the glass plate 10 may be a rectangular shape, a trapezoidal shape, a circular shape, or an elliptic shape, for example. The thickness of the glass plate 10 is appropriately set depending on an application of the glass plate 10; and the thickness of the glass plate is from 0.01 cm to 2.5 cm, for example.

The glass plate 10 includes a first principal plane 11 and second principal plane 12; and the glass plate 10 includes, at least at a part of an outer edge, a first adjacent surface 13; a second adjacent surface 14; and an edge face 15. The first principal plane 11 and the second principal plane 12 are parallel to each other. The first adjacent surface 13 intersects the first principal plane 11 at an obtuse angle. The second adjacent surface 14 intersects the second principal plane 12 at an obtuse angle. The edge face 15 is perpendicular to the first principal plane 11 and the second principal plane 12; and the edge face 15 connects the first adjacent surface 13 and the second adjacent surface 14. Since the first adjacent surface 13 and the second adjacent surface 14 are configured to be the same, the first adjacent surface 13 is exemplary described.

The first adjacent surface 13 is a cutting plane formed by an extension of a crack. During cutting of the glass plate 10, the first adjacent surface 13 is formed. Since chamfering is not required, processing time and processing cost can be reduced.

The first adjacent surface 13 may be a cutting plane formed by scanning a laser beam along at least a part of the outer edge of the glass plate 10. Here, scanning the laser beam means a displacement of a position at which the laser beam is irradiated. Since a structural color is observed, a cutting plane by a laser beam is superior in visibility, and in design.

To describe more specifically, as illustrated in FIG. 2, the first adjacent surface 13 forms a diffraction grating including at least one of a Wallner line and an Arrest line. A “Wallner line” is a striped line indicating a direction of an extension of a crack. An “Arrest line” is a striped line indicating a temporary halt of an extension of a crack. Hereinafter, the Wallner line and the Arrest line are collectively referred to as a line representing a state of an extension of a crack.

Since the first adjacent surface 13 forms a diffraction grating including at least one of the Wallner line and the Arrest line, upon visible light, such as sunlight, being irradiated, a structural color is observed due to diffraction and interference of the light. Consequently, visibility of the outer edge of the glass plate 10 is enhanced. Furthermore, since various colors are observed, as a color of the structure color changes depending on a viewing angle, a favorable design can be obtained.

A plurality of lines representing the state of the extension of the crack is preferably arranged along the outer edge of the glass plate 10 while the lines are separated by intervals. By arranging in this manner, if the intervals (pitches) between the lines 16 are the same, a greater number of lines 16 can be formed compared to a case where the lines 16 are arranged in a direction perpendicular to the outer edge of the glass plate 10, namely, a case where the lines 16 are arranged in a plate thickness direction of the glass plate 10. Thus, diffraction and interference of the light occur more often, so that the structural color tends to be observed.

Here, the lines 16 may not be formed over the whole circumference of the outer edge of the glass plate 10, and the lines 16 may be formed in a portion of the outer edge.

The pitch P of the lines 16 is from 0.1 μm to 1000 μm, for example. If the pitch P of the lines 16 is within the above-described range, a structure color tends to appear by diffraction and interference of the visible light. The pitch P of the lines 16 is preferably from 0.2 μm to 500 μm; and more preferably from 0.5 μm to 300 μm.

The pitch P of the lines 16 is measured by counting a number of the lines 16 in a length range of 1000 μm along the outer edge of the glass plate on a micrograph, for example.

Note that, if the pitch of the lines 16 is an equal pitch, diffraction and interference of the light tend to occur compared to a case of an irregular pitch, so that visibility and design can be enhanced.

Here, the fact that the pitch is an equal pitch means that both minimum value of the pitch and maximum value of the pitch are in a range of ±15% from an average value of the pitch, as a reference.

Note that, in at least a part of the diffraction grating formed by the lines 16, the lines 16 may be arranged with an equal pitch. In a region where the lines 16 are arranged with the equal pitch, diffraction and interference of the light tend to occur, so that visibility and design can be enhanced.

The lines 16 may be formed in such a manner that, when the lines 16 are viewed in a direction perpendicular to the first principal plane 11 and the second principal plane 12, the lines 16 are curved. The curved line can be decomposed into two components, which are perpendicular to each other. Consequently, an angular range where diffraction and interference of the light occur is enlarged compared to a case where the lines 16 are formed to be straight lines, so that the structural color can be observed in a wider angular range.

Note that the first adjacent surface 13 may be formed so that an angle formed between the first adjacent surface 13 and the first principal plane 11 exceeds 135 degrees. By forming this angle, a step at the boundary between the first adjacent surface 13 and the first principal plane 11 can be made less noticeable. In addition, touching feeling becomes smooth. It is preferably greater than or equal to 150 degrees. Further, the first adjacent surface 13 is formed to be a flat surface such that, when the first adjacent surface 13 is viewed in the cross section, the first adjacent surface 13 is a straight line. However, the first adjacent surface 13 may be formed to be a curved surface such that, when the first adjacent surface 13 is viewed in the cross section, the first adjacent surface 13 is an arc.

Surface roughness Ra (the arithmetic average roughness Ra described in JISB0601 of the Japanese Industrial Standards) of the first adjacent surface 13 is less than or equal to 100 nm, for example. If the surface roughness Ra is less than or equal to 100 nm, a sufficient degree of sparkle is obtained, and sparkler design can be obtained, which is different from the above-described design based on the structural color. The surface roughness Ra is preferably less than or equal to 50 nm, and more preferably less than or equal to 30 nm.

### EXAMPLES

### Example 1

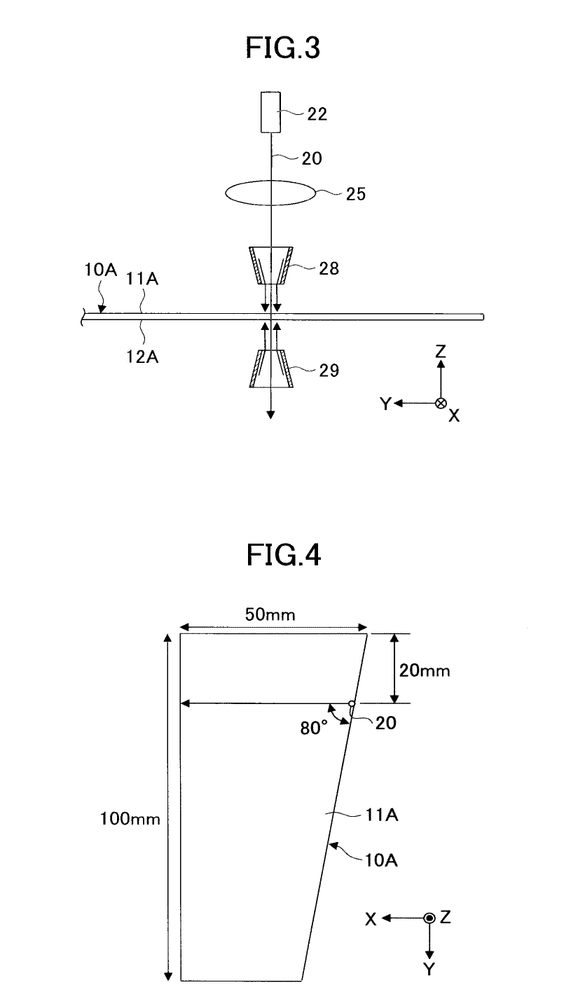

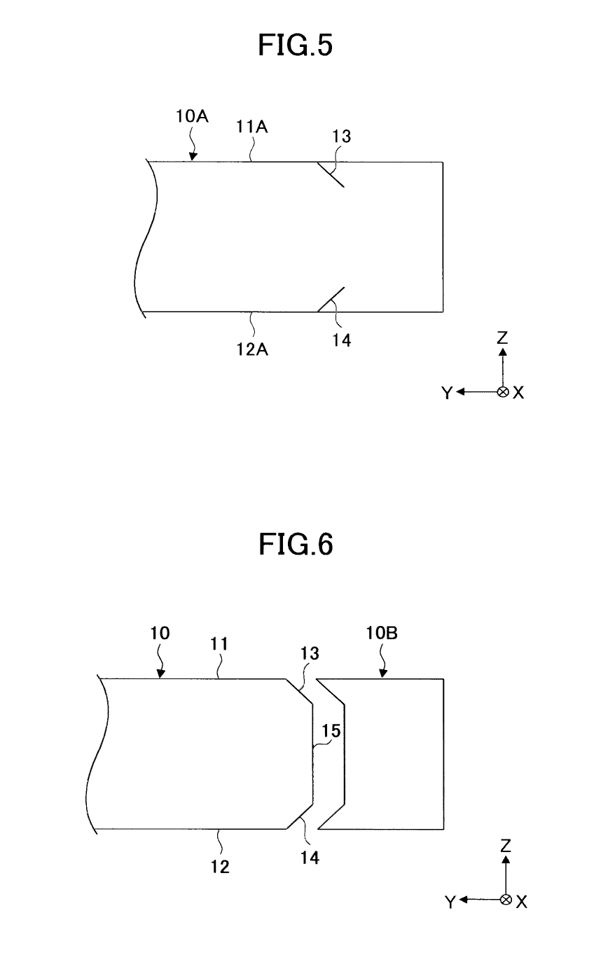

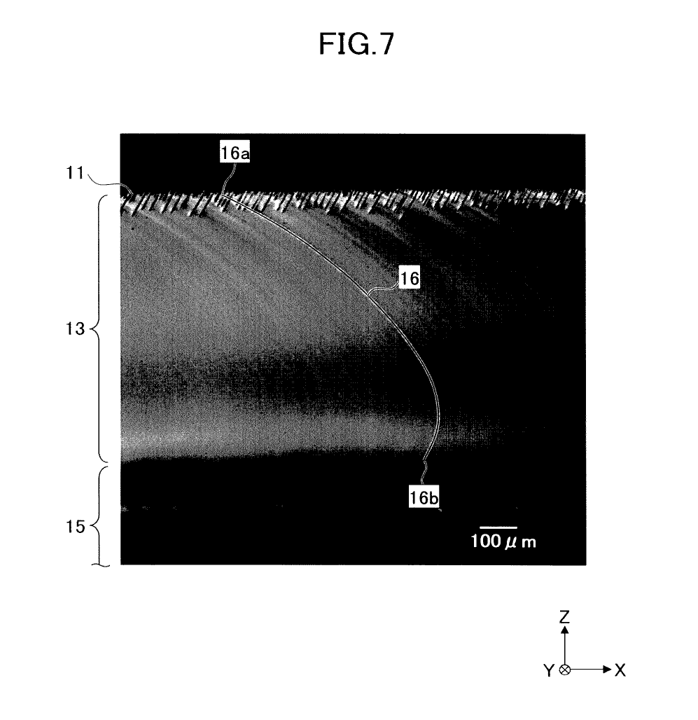

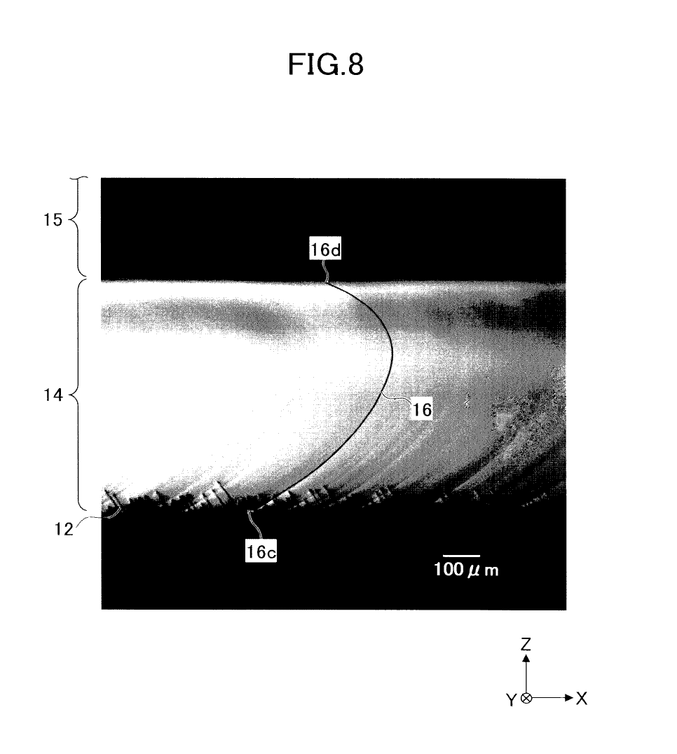

In Example 1, the glass plate illustrated in FIGS. 5-8 was obtained by the processing method illustrated in FIGS. 3-4. FIG. 3 is a side view illustrating the laser processing method of the glass plate according to Example 1. FIG. 4 is a plan view illustrating a scanning direction of a laser beam with respect to the glass plate of FIG. 3. FIG. 5 is a side view illustrating a state of the glass plate after the laser processing of FIGS. 3-4. FIG. 6 is a side view illustrating a state after stress is applied to the glass plate of FIG. 5. FIG. 7 is a micrograph of the first adjacent surface of the glass plate illustrated in FIG. 6. FIG. 8 is a micrograph of the second adjacent surface of the glass plate illustrated in FIG. 6. In FIG. 7 and FIG. 8, one line representing a state of an extension of a crack is highlighted.

In Example 1, the glass plate 10A was locally heated by using a laser beam 20 passing through the glass plate 10A from the first principal plane 11A to the second principal plane 12A; and an irradiation position of the laser beam 20 was varied. As the glass plate 10A, a glass plate having a thickness of 2.8 mm (a soda-lime glass produced by ASAHI GLASS CO., LTD.) was used. As a light source 22 of the laser beam 20, a Yb fiber laser (wavelength 1070 nm) was used, and the laser beam 20 was perpendicularly irradiated onto the first principal plane 11A. An absorption coefficient (α) the glass plate 10A with respect to the laser beam 20 was 0.57 cm⁻¹, and an internal transmittance was 85%. An internal transmittance is a transmittance for a case where it is assumed that there is no reflection on the first principal plane 11A. On the first principal plane 11A, the beam shape of the laser beam 20 was a circular shape with a diameter of 0.5 mm. A condensing lens 25 for condensing the laser beam 20 was installed between the light source 22 and the glass plate 10A. A focal position of the condensing lens 25 was a position that is separated from the first principal plane 11A toward the light source 22 by 11. 48 mm; and a converging angle was 2.5 degrees. The output of the light source 22 was 440 W. The laser beam 20 was scanned at speed of 70 mm/second parallel to the two parallel edges of the four edges of the glass plate 10A having a trapezoidal shape, which is illustrated in FIG. 4. An initial crack was formed in advance by a file in one edge that obliquely intersects the two parallel edges. The initial crack was formed at a position where irradiation of the laser beam 20 was started. The scanning direction of the laser beam 20 was tilted with respect to a tangential line of an outer edge of the glass plate 10A at the position where irradiation of the laser beam 20 was started. Since tensile stress was generated at the position onto which the laser beam 20 was irradiated, by varying the position onto which the laser beam 20 was irradiated, the crack was extended from the initial crack, as a starting point.

In Example 1, as a Yb fiber laser, a continuous oscillation type laser was used.

Further, in Example 1, as illustrated in FIG. 3, a first cooling nozzle 28 for spraying a cooling gas onto the first principal plane 11A of the glass plate 10A, and a second cooling nozzle 29 for spraying a cooling gas onto the second principal plane 12A were used, so that high tensile stress was generated at the position where the laser beam 20 was irradiated. The center line of the first cooling nozzle 28 and the center line of the second cooling nozzle 29 were aligned with an optical axis of the laser beam 20. Each of the first cooling nozzle 28 and the second cooling nozzle 29 had a circular exhaust port with a diameter of 1 mm; formed a gap of 15 mm with the glass plate 10A; and injected the cooling gas at a flow rate of 30 L/min. As the cooling gas, compressed air was used.

The glass plate 10A was relatively moved with respect to the light source 22, the first cooling nozzle 28, and the second cooling nozzle 29, so that the crack was extended from the initial crack, as the starting point. As a consequence, the first adjacent surface 13 that intersects the first principal plane 11A at an obtuse angle and the second adjacent surface 14 that intersects the second principal plane 12A at an obtuse angle could be simultaneously formed, as illustrated in FIG. 5. It was estimated that the reason that the first adjacent surface 12 and the second adjacent surface 14 were formed was that the scanning direction of the laser beam 20 (the X-direction in FIG. 4) was tilted with respect to the outer edge of the glass plate 10A at the position where irradiation of the laser beam 20 was started. After that, bending stress was applied to the glass plate 10A; and the glass plates 10 and 10B were obtained by forming the edge face 15 for connecting the first adjacent surface 13 and the second adjacent surface 14, as illustrated in FIG. 6.

The surface roughness Ra of the glass plate 10 was measured by using a surface roughness measurement device (SURFCOM200DX2 produced by TOKYO SEIMITSU CO., LTD.). The measurement conditions are described below.

Cut-off value λc: 0.08 mm

Cut-off ratio λc/λs: 30

Measurement speed: 0.03 mm/sec

Evaluation length: 0.4 mm

In the first adjacent surface 13, the line 16 representing the state of the extension of the crack was observed, as illustrated in FIG. 7. When the sunlight was irradiated onto the first adjacent surface 13, a structural color was observed due to diffraction and interference of the light, so that the glass plate was obtained that was superior in visibility of the outer edge. Furthermore, various colors were observed, as the color of the structural color was changed depending on the viewing angle, so that the glass plate was obtained that was superior in design. The lines 16 representing the state of the extension of the crack were arranged along one edge of the glass plate 10 while the lines 16 were separated by intervals. When the glass plate 10 was observed in a direction perpendicular to the principal plane of the glass plate 10, each line 16 was curved. The shape of the line 16 represents time-dependent variation of the position of the tip of the crack during laser scanning. In each line 16, an end portion 16a at the side of the first principal plane 11 was located behind an end portion 16b at the side of the edge face 15 in the scanning direction of the laser beam. From this, it can be seen that the crack was extended from an inner portion of the glass plate 10A toward the surface, rather than extending from the first principal plane 11A of the glass plate 10A toward the depth direction. According to the knowledge of the inventors, when a crack extends from an inner portion of the glass plate 10A toward a surface, the line 16 representing the state of the extension of the crack tends to occur. On the first adjacent surface 13, the pitch of the lines 16 was 58.8 μm, and the surface roughness Ra was 4.0 nm. The pitch of the lines 16 was an equal pitch. When the pitch of the lines 16 is an equal pitch, diffraction and interference of the light tend to occur, compared to a case of an irregular pitch, and visibility and design can be enhanced.

On the second adjacent surface 14, the line 16 representing the state of the extension of the crack was observed, as illustrated in FIG. 8. When the sunlight was irradiated onto the second adjacent surface 14, a structural color was observed due to diffraction and interference of the light, so that the glass plate was obtained that was superior in visibility of the outer edge. Furthermore, various colors were observed, as the color of the structural color was changed depending on the viewing angle, so that the glass plate was obtained that was superior in design. The lines 16 representing the state of the extension of the crack were arranged along one edge of the glass plate 10 while the lines 16 were separated by intervals. When the glass plate 10 was observed in a direction perpendicular to the principal plane of the glass plate 10, each line 16 was curved. The shape of the line 16 represents time-dependent variation of the position of the tip of the crack during laser scanning. In each line 16, an end portion 16c at the side of the second principal plane 12 was located behind an end portion 16d at the side of the edge face 15 in the scanning direction of the laser beam. From this, it can be seen that the crack was extended from an inner portion of the glass plate 10A toward the surface, rather than extending from the second principal plane 12A of the glass plate 10A toward the depth direction. On the second adjacent surface 14, the pitch of the lines 16 was 58.8 μm, and the surface roughness Ra was 5.0 nm. The pitch of the lines 16 was an equal pitch. When the pitch of the lines 16 is an equal pitch, diffraction and interference of the light tend to occur, compared to a case of an irregular pitch, and visibility and design can be enhanced.

Note that, in the embodiment, the example is illustrated in which the pitch is the equal pitch; however, the lines 16 may be formed with an irregular pitch.

### Example 2

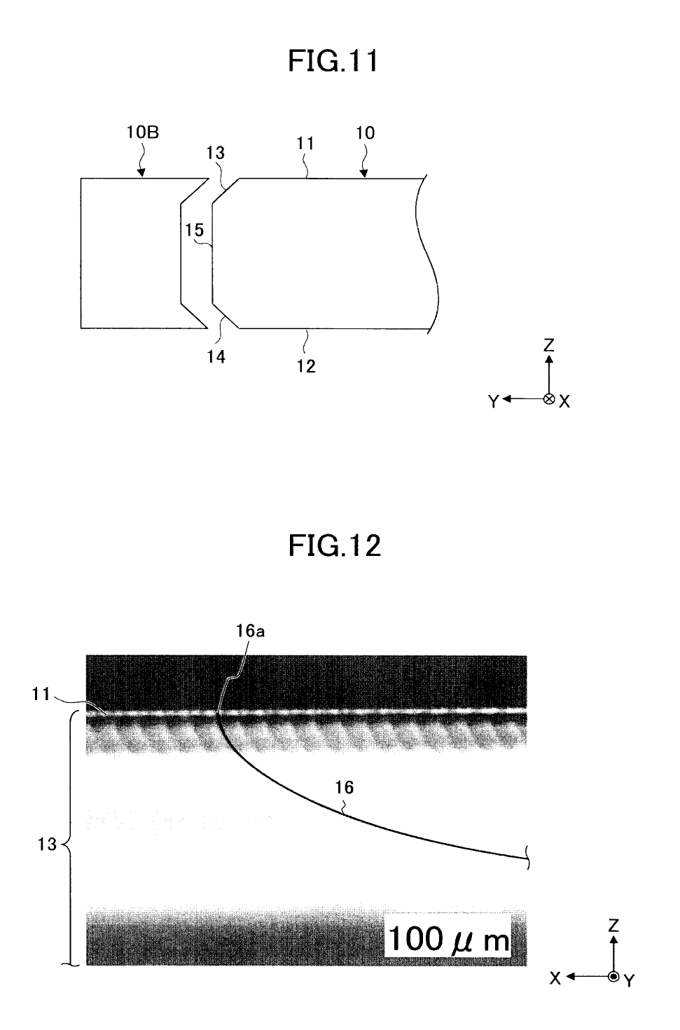

FIG. 10 is a plane view illustrating a scanning direction of a laser beam with respect to a glass plate in Example 2. FIG. 11 is a side view illustrating a state after stress is applied to the glass plate of FIG. 10. FIG. 12 is a micrograph of the first adjacent surface of the glass plate illustrated in FIG. 11. In FIG. 12, one line representing a state of an extension of a crack is highlighted.

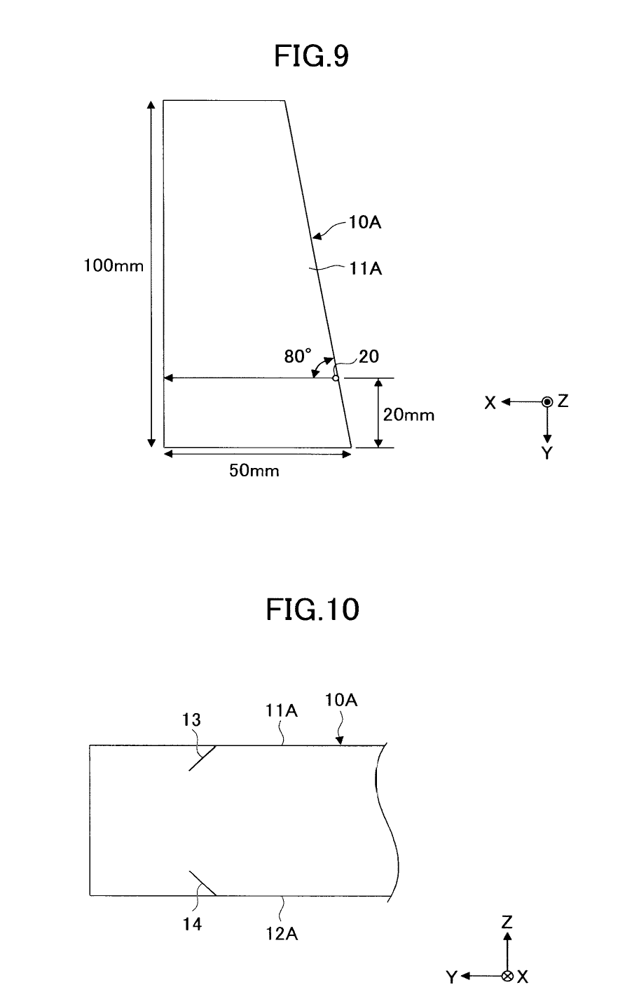

In Example 2, as illustrated in FIG. 10, front and rear surfaces of the glass plate 10A were switched compared to Example 1. The glass plate 10A was locally heated by using a laser beam 20 passing through the glass plate 10A from the first principal plane 11A to the second principal plane 12A; and an irradiation position of the laser beam 20 was varied. As the glass plate 10A, a glass plate having a thickness of 2.8 mm (a soda-lime glass produced by ASAHI GLASS CO., LTD.) was used. As a light source 22 of the laser beam 20, a Yb fiber laser (wavelength 1070 nm) was used, and the laser beam 20 was perpendicularly irradiated onto the first principal plane 11A. An absorption coefficient (α) the glass plate 10A with respect to the laser beam 20 was 0.57 cm⁻¹, and an internal transmittance was 85%. On the first principal plane 11A, the beam shape of the laser beam 20 was a circular shape with a diameter of 0.5 mm. The condensing lens 25 for condensing the laser beam 20 was installed between the light source 22 and the glass plate 10A. A focal position of the condensing lens 25 was a position that is separated from the first principal plane 11A toward the light source 22 by 9.06 mm; and a converging angle was 6.3 degrees. The output of the light source 22 was 100 W. The laser beam 20 was scanned at speed of 10 mm/second parallel to the two parallel edges of the four edges of the glass plate 10A having a trapezoidal shape, as illustrated in FIG. 9. An initial crack was formed in advance by a file in one edge that obliquely intersects the two parallel edges. The initial crack was formed at a position where irradiation of the laser beam 20 was started. The scanning direction of the laser beam 20 was tilted with respect to a tangential line of an outer edge of the glass plate 10A at the position where irradiation of the laser beam 20 was started. Since tensile stress was generated at the position onto which the laser beam 20 was irradiated, by varying the position onto which the laser beam 20 was irradiated, the crack was extended from the initial crack, as a starting point.

In Example 2, unlike Example 1, as a Yb fiber laser, a pulse oscillation type laser was used. A pulse width was set to 200 μs, and a repetition frequency was set to 400 Hz.

Further, in Example 2, unlike Example 1, out of the first cooling nozzle 28 and the second cooling nozzle 29 illustrated in FIG. 3, only the first cooling nozzle 28 was used, and the second cooling nozzle 29 was not used. The center line of the first cooling nozzle 28 was tilted backward in the scanning direction of the laser beam by 45 degrees with respect to the optical axis of the laser beam 20. The first cooling nozzle 28 had a circular exhaust port with a diameter of 1 mm; formed a gap of 10 mm with the glass plate 10A; and injected the cooling gas at a flow rate of 10 L/min. As the cooling gas, compressed air was used.

The glass plate 10A was relatively moved with respect to the light source 22, and the first cooling nozzle 28, so that the crack was extended from the initial crack, as the starting point. As a consequence, the first adjacent surface 13 that intersects the first principal plane 11A at an obtuse angle and the second adjacent surface 14 that intersects the second principal plane 12A at an obtuse angle could be simultaneously formed, as illustrated in FIG. 10. After that, bending stress was applied to the glass plate 10A; and the glass plates 10 and 10B were obtained by forming the edge face 15 for connecting the first adjacent surface 13 and the second adjacent surface 14, as illustrated in FIG. 11.

In Example 2, in the first adjacent surface 13, the line 16 representing the state of the extension of the crack was observed, as illustrated in FIG. 12. When the sunlight was irradiated onto the first adjacent surface 13, a structural color was observed due to diffraction and interference of the light, so that the glass plate was obtained that was superior in visibility of the outer edge. Furthermore, various colors were observed, as the color of the structural color was changed depending on the viewing angle, so that the glass plate was obtained that was superior in design. The lines 16 representing the state of the extension of the crack were arranged along one edge of the glass plate 10 while the lines 16 were separated by intervals. When the glass plate 10 was observed in a direction perpendicular to the principal plane of the glass plate 10, each line 16 was curved. In each line 16, an end portion 16a at the side of the first principal plane 11 was located ahead of an end portion 16b at the side of the edge face 15 in the scanning direction of the laser beam. From this, it can be seen that the crack was extended from the first principal plane 11 toward the depth direction in the glass plate 10A. Further, on the first adjacent surface 13, the pitch of the lines 16 was 25 μm. The pitch of the lines 16 was an equal pitch. When the pitch of the lines 16 is an equal pitch, diffraction and interference of the light tend to occur, compared to a case of an irregular pitch, and visibility and design can be enhanced.

Note that, for a case where a pulse oscillation type laser is used as a light source of a laser beam, by varying at least one of a pulse width and a repetition frequency, the pitch of the lines 16 can be controlled. The pitch of the lines 16 may be changed during laser scanning.

Additionally, for a case where a pulse oscillation type laser is used as a light source of a laser beam, reproducibility of the pitch of the lines 16 to be formed is favorable, compared to a case where a continuous oscillation type laser is used, so that desired visibility and design can always be formed on the outer edge of the glass plate.

The embodiments of the glass plate are described above. However, the present invention is not limited to the above-described embodiments, and various modifications and improvements may be made within the scope described in the claims.

For example, the glass plate 10 includes, at least at a part of the outer edge, both first adjacent surface 13 and second adjacent surface 14; however, it suffices if the glass plate 10 includes at least one of them. For example, the glass plate 10 may include the first adjacent surface 13, and the glass plate 10 may not include the second adjacent surface 14. In this case, the the edge face 15 may perpendicularly intersect the second principal plane 12. Alternatively, the glass plate 10 may include the second adjacent surface 14, and the glass plate 10 may not include the first adjacent surface 13. In this case, the the edge face 15 may perpendicularly intersect the first principal plane 11.

Further, the glass plate 10 includes, at least at a part of the outer edge, the edge face 15 that is perpendicular to the first principal plane 11 and the second principal plane 12. However, the shape of the edge face 15 is not particularly limited. For example, the edge face 15 may be an arc surface, instead of the flat surface.

Further, the glass plate 10 may be a flat plate or a curved plate; and the glass plate 10 may be any of a figured glass with a rugged pattern formed on the surface; a wired glass that includes a metal mesh or metal lines therein; a film-coated glass such that a functional film, such as an Anti Reflection (AR) film, is coated on the surface; a laminated glass; and a strengthened glass.

Furthermore, a method of manufacturing the glass plate 10 is not limited to the method illustrated in FIG. 3-FIG. 4. For example, in FIG. 3-FIG. 4, at the position where irradiation of the laser beam 20 is started, the outer edge of the glass plate 10 has a straight-line shape; however, the outer edge of the glass plate 10 may have a curved shape. The first adjacent surface 13 and the second adjacent surface 14 can be obtained as long as the scanning direction (the X-direction in FIG. 4) of the laser beam 20 is tilted with respect to the tangential line of the outer edge of the glass plate 10A at the position where irradiation of the laser beam 20 is started. In addition, in order to obtain the first adjacent surface 13 and the second adjacent surface 14, there is a method where a laser beam having an asymmetrical cross-sectional shape or an asymmetrical intensity distribution on the cross-section is irradiated onto the glass plate 10A. For example, by inserting a shielding plate in the middle of the optical path of the laser beam, the laser beam having the asymmetrical cross-sectional shape or the asymmetrical intensity distribution on the cross-section can be obtained. For a case where this laser beam is used, even if the scanning direction of the laser beam 20 is not tilted with respect to the tangential line of the outer edge of the glass plate 10A at the position where irradiation of the laser beam 20 is started, the first adjacent surface 13 and the second adjacent surface 14 can be simultaneously formed. Furthermore, in FIG. 3-FIG. 4, the first adjacent surface 13 and the second adjacent surface 14 are simultaneously formed by irradiation of the laser beam 20; however, only one of the first adjacent surface 13 and the second adjacent surface 14 may be formed. Additionally, in FIG. 3-FIG. 4, both first cooling nozzle 28 and second cooling nozzle 29 are used; however, one or both of the first cooling nozzle 28 and the second cooling nozzle 29 may not be used.

What is claimed is:

1. A glass plate comprising:
an adjacent surface that intersects a principal plane at an obtuse angle, the adjacent surface being, at lease, at a part of an outer edge,
wherein the adjacent surface is a cutting plane formed by an extension of a crack, and the adjacent surface forms a diffraction grating including at least one of a Wallner line and an Arrest line.

2. The glass plate according to claim 1, wherein the at least one of the Wallner line and the Arrest line is arranged along at least a part of an outer edge of the glass plate.

3. The glass plate according to claim 1, wherein, when the glass plate is viewed in a direction perpendicular to the principal plane, the at least one of the Wallner line and the Arrest line is curved.

4. The glass plate according to claim 1, wherein at least a part of the diffraction grating is formed of at least one of the Wallner lines arranged with an equal pitch and the Arrest lines arranged with an equal pitch.

5. The glass plate according to claim 1, wherein the adjacent surface is the cutting plane formed by scanning a laser beam along at least a part of an outer edge of the glass plate.

6. A method of processing a glass plate comprising:
a step of forming, in the glass plate, an adjacent surface that intersects a principal plane of the glass plate at an obtuse angle by locally heating the glass plate by irradiation of a laser beam, and by displacing a position where the laser beam is irradiated,
wherein the adjacent surface is a cutting plane formed by an extension of a crack, and the adjacent surface forms a diffraction grating including at least one of a Wallner line and an Arrest line.

7. A method of processing a glass plate comprising:
a step of simultaneously forming, in the glass plate, a first adjacent surface that intersects a first principal plane of the glass plate at an obtuse angle and a second adjacent surface that intersects a second principal plane of the glass plate at an obtuse angle by locally heating the glass plate by irradiation of a laser beam, and by displacing a position where the laser beam is irradiated,
wherein each of the first adjacent surface and the second adjacent surface is a cutting plane formed by an extension of a crack, and each of the first adjacent surface and the second adjacent surface forms a diffraction grating including at least one of a Wallner line and an Arrest line.
